(19) United States
(12) Patent Application Publication
(10) Pub. No.: US 2008/0026755 A1
(43) Pub. Date: Jan. 31, 2008

(54) Method and system for establishing a multiple transfer mode session

(75) Inventors: Ramesh Venkataraman, Schaumburg, IL (US); Vipul S. Dalal, Glendale Heights, IL (US); Kris A. Seeley, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/493,089

(22) Filed: Jul. 26, 2006

(51) Int. Cl. H04Q 7/20

(52) U.S. Cl. 455/436

(57) ABSTRACT

A method and system is provided for supporting a Mobile Station (MS) (110) that is capable of Multiple Transfer Mode (MTM) communication in a telecommunications network, when the MS (110) is handed over from a MTM non-enabled cell (102) to an MTM-enabled cell (102). The method includes transmitting an information message to the MS (110) by using Fast Access Control Channel (FACCH) signaling.

### FIELD OF THE INVENTION

This invention relates in general to mobile communication networks, and more specifically, to Dual Transfer Mode (DTM) sessions in mobile communication networks.

### BACKGROUND OF THE INVENTION

With advances in mobile communication technologies, users are now offered the possibility of multiple simultaneous transfers. The technologies that support multiple simultaneous transfers are Multi Transfer Mode (MTM) technologies. An example of MTM is DTM that enables simultaneous transmission of voice and packet data by a user in a mobile communication network. A prerequisite to use the DTM technology is that the Mobile Station (MS) and the mobile communication cell in which the user of the MS is present should both support DTM. An example of a mobile communication network that supports DTM is a GSM EDGE Radio Access Network (GERAN).

However, before the user can simultaneously transmit voice and data, the MS and the base station servicing the cell have to establish a Circuit Switched (CS) session and a Packet Switched (PS) session. The CS session is established after the handover of the MS to the cell is complete. However, when a DTM-capable MS moves from a cell, which is not DTM-enabled, to a DTM-enabled cell, it must wait to receive a System Information broadcast (SI6), to understand that the cell is DTM-enabled. SI6 messages are sent only periodically from the DTM-enabled cell. Thereafter the MS requests the DTM-enabled cell to establish a PS session. This is as defined by 3GPP specifications. The transmission of SI6 by the cell is scheduled along with other SI messages, which are primarily SI5 messages.

The time taken for the MS to request the DTM-enabled cell to establish a PS session ranges from 700 ms to 2500 ms. The period of time for SI6 messages to be sent depends on a number of factors including the number of out-of-band and multi-rate RAT neighbors are configured. For example, when there are 8 in-band neighbors it takes approximately 700 ms to transmit the SI6 message using standard protocol procedures. For 4-in-band neighbors, 2 out-of-band neighbors and 2 multi-rate neighbors, it can take up to 2400 ms to transmit the SI6 message according to standard protocol procedures. This delay, along with the time required to reconfigure the Transmit Channel (TCH) into a Packet Data Channel (PDCH), can increase the time taken to establish the PS session, and hence the user experience can be perceived as unfavorable.

Hence, there is a need for a method that reduces the time taken by an MS to establish a Multi Transmission Mode session.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating an environment where various embodiments can be implemented;

FIG. 2 is a flow diagram illustrating a method for supporting a Mobile Station when the Mobile Station is handed over from a Dual Transfer Mode non-enabled cell to a Dual Transfer Mode-enabled cell, in accordance with an embodiment; and

FIG. 3 is a call flow chart illustrating a sequence of events when a Mobile Station is handed over from a Dual Transfer Mode non-enabled cell to a Dual Transfer Mode-enabled cell, in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail the particular method and system for establishing a multiple transfer mode session in accordance with the present invention, it should be observed that the present invention resides primarily in combinations of method steps and apparatus components related to method and system for pre-authentication by collecting the information in the wireless network. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising”, “includes”, “including”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising.

In an embodiment, a method for supporting a Mobile Station (MS) that is capable of Multiple Transfer Mode (MTM) communication in a telecommunications network when the MS is handed over from a MTM non-enabled cell to an MTM enabled cell is provided. The method includes transmitting an information message to the MS, using Fast Access Control Channel (FACCH) signaling. The information message contains data that notifies the MS that it can be using MTM communications and the MS can then proceed into that mode.

In another embodiment, a method for establishing a Dual Transfer Mode (DTM) session between a Mobile Station (MS) and a target Base Transceiver Station (BTS) is provided. Both the MS and the target BTS are DTM-enabled. The method includes a source BTS handing over the MS to the target BTS. The source BTS is DTM non-enabled. The method also includes establishing a Circuit Switched (CS) connection between the MS and the target BTS. Moreover, the method includes a DTM information message being transmitted by the target BTS to the MS by using a transfer channel. The transmission of the DTM information message is carried out by using Fast Associated Control Channel (FACCH) signaling. After receiving the DTM information message, the MS makes a request to the target BTS for DTM.

In yet another embodiment, a system is provided. The system includes a source base transceiver station (BTS), a target BTS, and a mobile station (MS). The source BTS is dual transfer mode (DTM) non-capable whereas the target BTS is DTM capable. The MS is capable of operating in a non-DTM environment as well as a DTM environment. The MS is handed over from the source BTS to the target BTS. The target BTS sends a message over a Fast Access Control Channel (FACCH) to the MS after the handover is completed, to establish DTM.

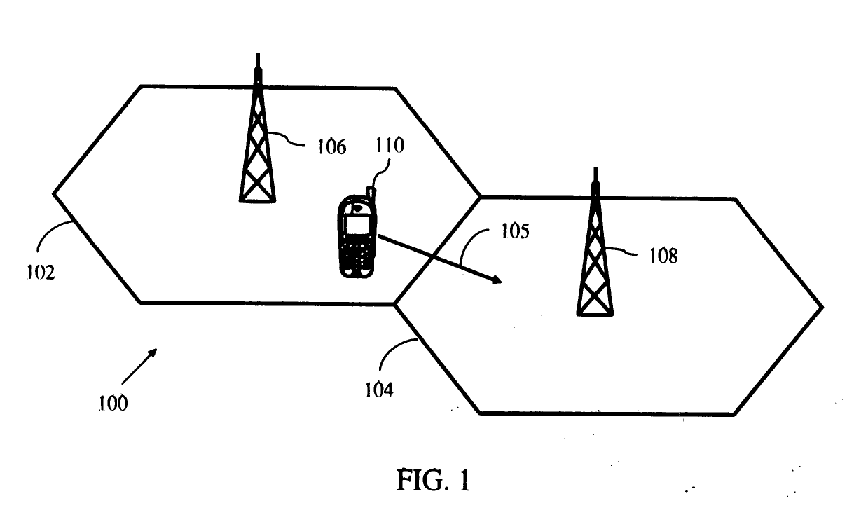

FIG. 1 is a block diagram illustrating an environment 100, where various embodiments can be practiced. The environment 100 includes a plurality of cells. A subset of the plurality of cells includes Multi Transfer Mode (MTM)-enabled cells, while the remaining cells are MTM non-enabled cells. Cells that can simultaneously support multiple switching services are MTM enabled cells, while those that support only a single switching service at a given point of time are MTM non-enabled cells. In an embodiment, the plurality of cells include a DTM non-enabled cell 102 and a DTM enabled cell 104. It will be apparent to those skilled in the art that the environment 100 can include any number of cells. The cell 102 is supported by a Base Transceiver Station (BTS) 106, while the cell 104 is supported by a BTS 108. The BTS 106 is a DTM non-enabled BTS, while the BTS 108 is a DTM enabled BTS. A cell or a BTS is DTM enabled when it supports Packet Switching and Data Switching simultaneously. In other words, a cell or a BTS is DTM enabled when it supports voice and data connectivity simultaneously for the same mobile. An example of a DTM enabled network is a GSM/GPRS EDGE Radio Access Network (GERAN). The GERAN offers functionality that supports seamless handling of Packet Switching and Data Switching services. The environment 100 also includes a Mobile Station (MS) 110. In an embodiment, the MS 110 moves from the cell 102 to the cell 104 (as shown by arrow 105). Hence, the cell 102 is referred to as a source cell and the cell 104 is referred to as a target cell. Similarly, the BTS 106 is referred to as a source BTS and the BTS 108 is referred to as a target BTS. The MS 110 is DTM enabled. In other words, it is capable of transmitting voice and data packets simultaneously. Typically, DTM enabled mobile stations are categorized as Class A devices, while DTM non-enabled mobile stations are categorized as Class B devices.

When the MS 110 is in the cell 102, it acts as a Class B device. In other words, it supports either Packet Switching or Data Switching at a given point, but not both simultaneously. The MS 110 is required to revert to a Class A device on entering the cell 104. This is possible only after the cell 104 informs the MS 110 that the cell 104 can support DTM. The MS 110 must wait to receive a SI6 (System Information broadcast) from the BTS 108 to understand that the DTM enabled cell 104 is DTM capable before initiating or resuming a DTM transaction. This is as per the norm defined by 3GPP specifications.

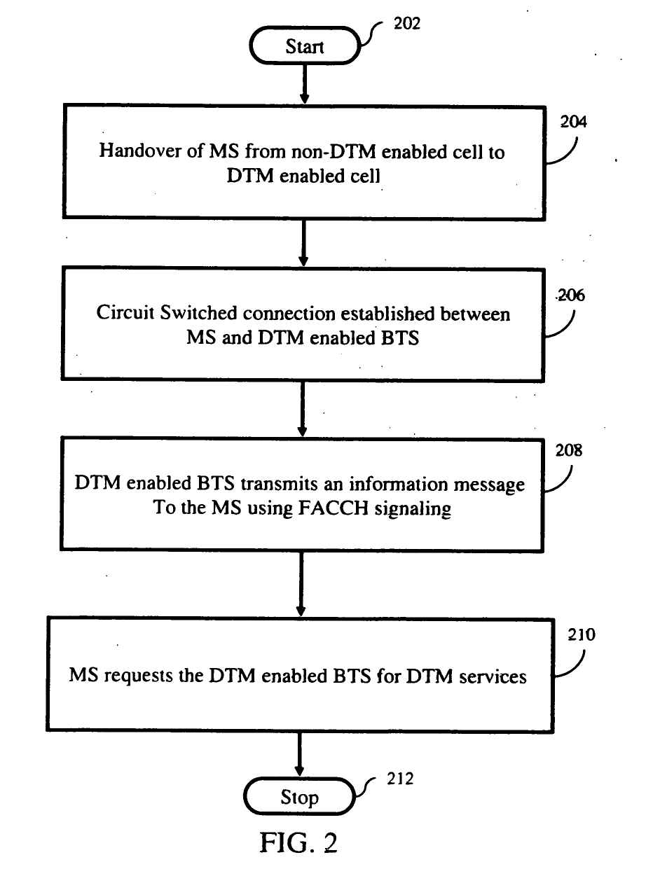

FIG. 2 is a flow diagram illustrating a method for supporting the MS 110 when the MS 110 is handed over from the MTM non-enabled cell 102 to the MTM enabled cell 104, in accordance with an embodiment. The method is initiated at step 202. At step 204, the MS 110 is handed over by the cell 102 to the cell 104. Handing over of the MS 110 is initiated when a Base Station Controller (BSC) detects that the BTS 108 is better suited to service the MS 110 than the BTS 106. This may be because the user of the MS 110 is closer to the BTS 108 than the BTS 106 or for other known reasons. The BSC issues a handover command to the MS 110 over a main Dedicated Control Channel (DCCH). The MS 110 then requests the BTS 108 for handover access over the main DCCH. The BTS 108 responds to the request by transmitting physical information regarding the connection between MS 110 and BTS 108 to the MS 110 over the main DCCH. After the MS 110 receives the physical information, a signaling link is established between the MS 110 and the BTS 108. Once a signaling link is established between the MS 110 and the BTS 108, the handover of the MS 110 from the cell 102 to the DTM enabled cell 104 is performed.

At step 206, a Circuit Switched (CS) connection is established between the MS 110 and the BTS 108 as a part of the handover process as described above. Establishing the CS connection between the MS 110 and the BTS 108 involves the BSC issuing a Radio Frequency (RF) channel release request to the BTS 106. The RF channel to be released by the BTS 106 is the one associated with the MS 110. After the BTS 106 releases the RF channel, the BTS 106 transmits an acknowledgement to the BSC. Once the RF channel associated with the MS 110 is released by the BTS 106, the BTS 108 is able to reserve an RF channel for the CS connection and associate it with MS 110.

At step 208, the BTS 108 transmits an information message to the MS 110 by using a Traffic Channel (TCH). In an embodiment, transmission of the information message is carried out by the BTS 108 before the transmission of other known system messages. The information message informs the MS 110 that the BTS 108 is capable of supporting DTM. The signaling used to transmit the information message is Fast Associated Control Channel (FACCH) signaling, which transmits data by utilizing frames on TCH for short periods. The FACCH is typically a signaling channel that is used to carry signaling information when there is a voice call. It is not intended to be used for the purpose as disclosed. Hence, signaling speech data is replaced with information message data in FACCH. FACCH signaling is also called in-band signaling. In an embodiment, the information message transmitted is a DTM information message. On receiving the DTM information message, the MS 110 becomes aware that the BTS 108 is capable of DTM operations. By using the FACCH channel, the MS 110 can proceed to take the necessary steps to operate as a DTM device with connections to both the CS and PS sessions without waiting for the SI6 messages as previously required, and as described below.

At step 210, the MS 110 makes a request for DTM to the BTS 108. The MS 110 makes this request over the main DCCH. On receiving the request, the BTS 108 starts the standard DTM call-establishment procedure. The standard DTM call-establishment procedure requires the BTS 108 to prepare a packet data channel. Once the call-establishment procedure is successfully completed, a Temporary Block Flow (TBF) is established between the MS 110 and the BTS 108, and a Packet Switched (PS) connection is established between the MS 110 and the BTS 108. Thereafter, the MS 110 can simultaneously transmit voice and packet data. The method is then terminated at step 212.

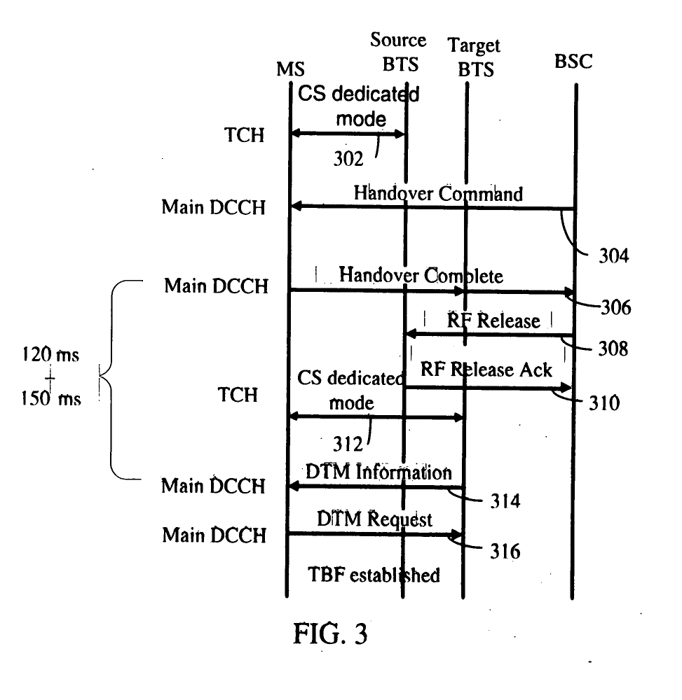

FIG. 3 is a call flow chart illustrating the sequence of events when the MS 110 is handed over from a DTM non-enabled cell to a Dual Transfer Mode enabled cell, in accordance with an embodiment. To begin, the MS 110 is associated 302 with the BTS 106. While the MS 110 is associated with the BTS 106, it is either in the CS-dedicated mode or the PS-dedicated mode. At some point in time after establishing a connection with BTS 106, the BSC detects that the BTS 108 is better suited to service the MS 110 than the BTS 106. This happens when the MS 110 moves from the cell 102 to the cell 104. After this, the BSC issues a handover command 304 to the MS 110 over a main DCCH. After following handover procedures, the handing over of the MS 110 is complete 306 and the MS 110 is associated with the BTS 108. Thereafter, the BSC issues 308 a Radio Frequency (RF) channel release request to the BTS 106. The RF channel to be released by the BTS 106 is the one associated with the MS 110. The BTS 106 releases the RF channel and transmits 310 an acknowledgement to the BSC. The MS 110, which is now associated with the BTS 108, is then in a dedicated CS mode 312. The BTS 108 transmits 314 a DTM information message to the MS 110 using a Transfer Channel (TCH).

In an embodiment, the DTM information message of step 314 is transmitted to the MS 110 by using the main DCCH. The signaling used to transmit the DTM information message is Fast Associated Control Channel (FACCH) signaling. It should be noted that the time that has elapsed between the step 306 and the step 314 ranges between 120-150 ms. In other words, the BTS 108 is able to inform the MS 110 about its capability to support DTM services within 120-150 ms.

After receiving the DTM information in step 314, the MS 110 requests 316 the BTS 108 for DTM. The MS 110 makes this request over the main DCCH. On receiving the request, the BTS 108 starts the standard DTM call-establishment procedure. Once the call-establishment procedure is successfully completed, a Temporary Block Flow is established between the MS 110 and the BTS 108. A Packet Switched (PS) connection is now established between the MS 110 and the BTS 108. The MS 110 can now transmit voice and packet data simultaneously.

The method and system described above for establishing a multiple transfer mode session offers various advantages. The proposed solution offers a significant improvement in DTM establishment time. The time saving can be between 570 ms to 2250 ms, as compared to the solution recommended by the 3GPP specification. This solution provides consistent performance improvements for various scenarios, and improves the end user's perception of the data service while using DTM.

In an embodiment of the invention, the BTS 108 may be aware of a previous DTM session between the BTS 108 and the MS 110 because a non-zero value exists for the packet session that is established as described above. The non-zero value is a part of the DTM information that is sent in step 314.

It will be appreciated the client described herein may be comprised of one or more conventional processors and unique stored program instructions that control the one or more processors to implement, in conjunction with certain non-processor circuits, some, most, or all of the functions of the client described herein. The non-processor circuits may include, but are not limited to, a radio receiver, a radio transmitter, signal drivers, clock circuits, power source circuits, and user input devices. As such, these functions may be interpreted as steps of a method to perform {accessing of a communication system}. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for supporting a Mobile Station (MS) capable of Multiple Transfer Mode (MTM) communication in a telecommunication network when the MS is handed over from a MTM non-enabled cell to an MTM enabled cell, the method comprising transmitting an information message to the MS using Fast Access Control Channel (FACCH) signaling.

2. The method of claim 1 wherein the MTM is a Dual Transfer Mode (DTM).

3. The method of claim 1 wherein transmitting MTM communication comprises transmitting Circuit Switched (CS) data and Packet Switched (PS) data.

4. The method of claim 1 further comprising establishing a Circuit Switched (CS) connection and a Packet Switched (PS) connection between the MS and the MTM enabled network.

5. The method of claim 1 wherein transmitting the information message comprises transmitting an DTM information message.

6. The method of claim 1 wherein transmitting of the information message occurs after the MS is handed over from the MTM non-enabled cell to the MTM enabled cell.

7. The method of claim 1 further comprising establishing a packet data channel.

8. The method of claim 7 wherein the packet data channel being established in approximately 120-150 msecs.

9. The method of claim 1 wherein transmitting the information message occurs prior to sending a system information message.

10. A method for establishing a Dual Transfer Mode (DTM) session between a Mobile Station (MS) and a target Base Transceiver Station (BTS) in a telecommunication network, wherein the MS and the target BTS are DTM enabled, the method comprising:
handing over of the MS to the target BTS by a source BTS, wherein the source BTS is a DTM non-enabled BTS;
establishing a Circuit Switched (CS) connection between the MS and the target BTS;
transmitting DTM information message by the target BTS to the MS using a transfer channel, wherein the DTM information message is transmitted using Fast Associated Control Channel (FACCH) signaling; and
requesting the target BTS for DTM by the MS.

11. A system comprising:
a source base transceiver station (BTS), the source BTS being dual transfer mode (DTM) non-enabled;
a target BTS being DTM capable;
a mobile station (MS) being DTM non-enabled and DTM enabled and wherein the MS is handed over from the source BTS to the target BTS and wherein the target BTS sends a message after handover is completed over a fast access control channel (FACCH) to the MS to establish DTM.
